(19) United States
(12) Patent Application Publication
(10) Pub. No.: US 2014/0027957 A1
(43) Pub. Date: Jan. 30, 2014

(54) DEVICE FOR MANUFACTURING A COMPOSITE PART INCLUDING A BELL AND ASSOCIATED METHOD

(71) Applicant: AIRBUS OPERATIONS (S.A.S.), Toulouse (FR)

(72) Inventors: Philippe Blot, Nantes (FR); Pierrick Tessier, Herbignac (FR)

(73) Assignee: AIRBUS OPERATIONS (S.A.S.), Toulouse (FR)

(21) Appl. No.: 13/949,981

(22) Filed: Jul. 24, 2013

(30) Foreign Application Priority Data
Jul. 26, 2012 (FR) 12 57256

(51) Int. Cl. B29C 70/02

(52) U.S. Cl. CPC B29C 70/026
USPC 264/526; 425/112

(57) ABSTRACT

The main purpose of the invention is a device for manufacturing a composite part, comprising a mould, designed to be associated with a reinforcement of the composite part comprising a preform, into which the resin forming the matrix of the composite part will be injected, possibly a support element on which the mould is supported, a preform vacuum creation membrane supported on the mould and/or the support element, if there is one; characterised in that it also comprises a vacuum chamber covering the vacuum creation membrane, the vacuum chamber comprising a flexible wall designed to apply a mechanical pressure to the vacuum creation membrane.

### TECHNICAL DOMAIN

This invention relates to the domain of fabrication of parts made from composite materials. More particularly, it relates to a device for fabrication of a composite part and the method for manufacturing a composite part manufactured using this device. A “composite part” means a part made from one or more composite materials.

For example, the invention can be applied to aeronautics, particularly for fabrication of composite parts that can be installed on an aircraft.

### STATE OF PRIOR ART

The properties and advantages of composite materials are well known. Thus, a composite material produced by an assembly of at least two immiscible materials has better properties, for example in terms of lightweight or stiffness, than the materials taken individually. More specifically, a composite material comprises a structure called reinforcement that provides mechanical strength, and a protection called a matrix that maintains the cohesion of the material and retransmits forces to the reinforcement. The reinforcement usually comprises a fibrous preform and the matrix usually comprises a resin, for example a thermoplastic or thermosetting resin.

Furthermore, several types of methods for manufacturing composite parts are known. For example, the following describes a vacuum-assisted Resin Transfer Moulding (RTM) method and two examples of surface infusion methods, namely Liquid Resin Infusion (LRI) and Modified Vacuum Infusion (MVI).

With reference to FIG. 1, the figure shows a sectional view of an example device 10 for manufacturing a composite part by using the vacuum-assisted RTM method. The vacuum-assisted RTM method thus consists of placing a fibrous preform (reinforcement) between the first part 1a and the second part 1b of a two-part mould that is stiff and heating, and injecting the resin (matrix) at the injection points (shown by arrows I in FIG. 1) so as to come into contact with the preform 2 to form the composite part. The mould 1 is also located on a support element 3 and is placed under a vacuum bag 4, the vacuum for example being made in the vacuum bag 4 at a V vacuum connector. Seals 5 are also inserted between the support element 3 and the vacuum bag 4, and a drain felt 6 may be provided between the vacuum bag 4 and the mould 1. Residual air in the preform 2 may be drawn off through the suction holes 7 formed in the mould 1. This method may be used to obtain better impregnation quality of resin in the preform, better control of the geometry (even complex) of the composite part to be moulded, particularly to obtain two smooth faces, and a reduction of costs in fabrication of the mould.

With reference to FIGS. 2 and 3, the figures show a sectional view of two example devices 10 for manufacturing a composite part by use of the LRI method and the MVI method, which are two surface infusion methods. The LRI and MVI methods consist of placing a fibrous preform 2 between a rigid mould 1 and a vacuum bag 4, using a surface resin diffuser 8 placed either under the dry preform 2 for the LRI method, or placed on the preform 2 for the MVI method. The surface resin diffuser 8 is usually a material that is very permeable to resin and consequently, the resin injection operation is limited practically to infusion of resin through the preform 2. The fact of using a vacuum bag 4 instead of a counter-mould, as for the RTM method, means that large parts can be injected and the fabrication cost can be reduced. Consequently, these methods are well adapted to the production of large composite parts.

However, these known methods of manufacturing composite parts have several disadvantages.

Indeed, the injection pressure for all these resin injection transfer mould methods is less than atmospheric pressure. This leads to many constraints during the fabrication of composite parts; a limitation on the possible dimensions of the preform (and therefore for the part to be moulded), particularly a limitation of the length for the vacuum-assisted RTM method and a limitation of the thickness for the LRI and MVI methods, due to the increase in pressure losses with the length or thickness of the preform; a limitation of the volume content of fibres in the part to be manufactured, and therefore a limitation of performances of the part in terms of weight and resistance due to the increase in pressure losses in the preform with the volume content of fibres; a limitation in the choice of suitable materials for making the preform, particularly a limitation to permeable materials (for example multiaxial fabric type materials) although the use of some single-directional and only slightly permeable materials is sometimes preferable for some applications, among others.

Solutions have already been suggested to increase the resin injection pressure, particularly by placing the mould in a drying oven or a closed and pressurized containment.

For example, U.S. Pat. No. 5,863,452 describes a device for manufacturing composite materials that comprises a chamber inside which there are two parts of a mould forming a cavity to contain a fibrous preform that can be pressurised at a pressure greater than the pressure of the resin injected in the cavity. U.S. Pat. No. 6,257,858 discloses the use of the RTM method in a containment containing the two-part mould and the fibrous preform pressurised to a pressure greater than the resin injection pressure. Finally, patent application U.S. 2004/0000745 discloses the possibility of adding a two-part chamber so that a pressure can be applied, to known devices for RTM methods.

However, the injection of resin by means of a drying oven (or pressurised containment) does have several disadvantages and constraints.

In particular, the pressure increase in the drying oven (or containment) increases risks of leaks between the oven and the inside of the mould during the resin injection operation. The seal of the vacuum bag, mould joints, connectors, pipes, vents and injection points in the mould is not absolute and strongly reduces as the drying oven pressure increases, which may for example cause risks of the vacuum bag bursting. Consequently, a gas (or even fluid) inlet from the drying oven can take place in the mould in contact with the resin due to the excess pressure in the drying oven, which can then cause porosities (or even dry zones) in the moulded composite part, therefore making it necessary to scrap the part. Furthermore, the use of a drying oven or a pressurised containment introduces technical difficulties in being able to pass resin injection pipes or vacuum creation pipes through the walls of the drying oven or the containment. Furthermore, such methods usually require the use of specific resin injection pipes that have good resistance to outside pressure that can resist the pressure of the containment and cannot be reused, which increases the cost of the fabricated composite part. Finally, the magnitude of the volume of the containment to be pressurised and the thermal constraints associated with these methods increase the duration and the cost of composite part manufacturing cycles.

### PRESENTATION OF THE INVENTION

In particular, there is a need to propose an alternate solution to known solutions to increase the resin injection pressure during fabrication of a composite part above the outside pressure (atmospheric pressure), while maintaining an efficient manufacture of the part, particularly in terms of quality.

The purpose of the invention is to at least partially satisfy such a need and the other needs mentioned above, and the disadvantages related to embodiments according to prior art.

Thus, according to one aspect of the invention, its purpose is a device for manufacturing a composite part, comprising:

a mould designed to be associated with a reinforcement of the composite part comprising a preform into which the resin forming the matrix of the composite part will be injected;

possibly a support element on which the mould is supported;

a preform vacuum creation membrane supported on the mould and/or the support element if there is one;

characterised in that it also comprises a vacuum chamber covering the vacuum creation membrane, the vacuum chamber comprising a flexible wall designed to apply a mechanical pressure on the vacuum creation membrane, so as to increase the resin injection pressure.

The term [symbol] vacuum chamber [symbol] for the purpose of this invention refers to any element capable of covering the vacuum creation membrane. For example, the vacuum chamber may be composed of a cover plate placed above the vacuum creation membrane. When observed in section, the vacuum chamber may comprise two side walls connected to each other by a single base capable of being supported on the mould and/or the support element as can be seen for example in FIG. 4 described below. The vacuum chamber may be approximately in the shape of a bell. Therefore, the term [symbol] bell [symbol] may also be used to designate the vacuum chamber.

With the invention, the resin injection pressure may be greater than the outside pressure equal to atmospheric pressure, such that if there is a loss of seal, leaks will take place from the inside of the mould towards the outside, which strongly reduces the risks of having porosities and/or dry zones in the fabricated composite part and thus improves the quality of the part.

The vacuum chamber in the device according to the invention and particularly the flexible wall of the vacuum chamber, can also help to maintain contact on the vacuum creation membrane, even in the case of a leak, which can improve the efficiency of fabrication of a composite part by reducing the risk of the part being scrapped.

Furthermore, the possibility of injecting resin at a pressure greater than atmospheric pressure can provide a means of using preforms with higher pressure losses, and therefore for example increasing the surface of the part for the RTM method or the thickness for the LRI and MVI methods, or choosing less porous fibrous materials for the preforms, and also to use more viscous resins.

Furthermore, the composite part manufactured according to the invention has enhanced properties, particularly a better fibre content and therefore a higher specific resistance because the feed pressure (resin pressure at the end of the injection) is higher than for conventional methods. Thus, the compaction pressure (in the vacuum chamber) can be significantly increased after the end of injection.

Furthermore, the invention makes it easier to design parts with complex geometry, to reduce manufacturing cycles time and reduce costs, particularly due to the use of pipes and conventional connectors.

The invention can usually improve the efficiency of known LRI and MVI vacuum-assisted RTM methods, particularly by making them more tolerant at the seal.

The device according to the invention may also comprise one or several of the following characteristics taken individually or in any technically possible combination.

The mould may be composed of one or several parts. In particular, the mould may comprise several parts forming at least one cavity between them to house the preform.

For example, the preform may be located on the mould, between parts of the mould or inside the mould.

The mould may comprise one or several resin injection holes.

The mould may comprise one or several suction holes to draw out residual air located in the preform.

The device may comprise at least one seal and particularly two seals at the interface between the vacuum creation membrane and the mould and/or the support element if any.

The vacuum creation membrane (or vacuum bag) is used to create a vacuum in all or part of the mould. In particular, the vacuum creation membrane may be used to create a vacuum in the zone in which the composite part is fabricated. The vacuum creation membrane may possibly enable creation of a vacuum in at least one zone of a previously fabricated composite part to be repaired.

The vacuum creation membrane may also be supported on the mould and/or possibly the support element on each side of the preform by means of two seals, when observed in section.

The vacuum creation membrane may comprise a vacuum connector to create a vacuum in the zone covered by the membrane.

The vacuum chamber may be capable of entirely covering the vacuum creation membrane by being supported on the mould and/or the support element if any, on each side of the preform.

The vacuum chamber may be suitable for placing the periphery of the mould under atmospheric pressure, including at the vacuum creation membrane.

The section of the vacuum chamber may be any shape, for example semi-rectangular or semi-circular.

The vacuum chamber may only partially cover the mould. The vacuum chamber in particular may not cover the entire circumference of the mould. In particular, the vacuum chamber is not the same as a closed containment (or dry oven) inside which the mould is placed.

The flexible wall (or bladder) may be made of an inflatable and/or deformable material.

The flexible wall may be connected to the periphery of the vacuum chamber. In particular, when observed in section, the flexible wall can extend between two opposite edges of the vacuum chamber.

The vacuum chamber may comprise at least one seal that will bear on the mould and/or the support element if any.

The vacuum chamber may comprise an inlet connector for the passage of a fluid, particularly a coolant, into the vacuum chamber at the contact with the flexible wall. In particular, the presence of such a fluid in the vacuum chamber can improve heat transfer to the composite part in order to reduce part fabrication cycle times.

The device may comprise a porous material, particularly a drain felt, between the vacuum creation membrane and the flexible wall of the vacuum chamber. The presence of such a porous material helps to make sure that the entire mould is at atmospheric pressure and it can help to remove the injection resin if there is a leak in the vacuum creation membrane.

The device may also comprise a press clave.

The press clave may be made from a single part on which the vacuum chamber fitted with the flexible wall is installed.

As a variant, the press clave may be in two parts comprising a first part on which the mould is supported and a second part on which the vacuum chamber fitted with the flexible wall is installed.

The device may also comprise a surface resin diffuser, designed particularly to be placed under the preform or on the preform.

In particular, the preform may be a fibrous preform, particularly a textile preform.

Another purpose of the invention according to another of its aspects, is a method of manufacturing a composite part by means of a device as defined above, comprising the step consisting of covering the vacuum creation membrane with the vacuum chamber such that the flexible wall of the vacuum chamber applies a mechanical pressure on the vacuum creation membrane such that the resin injection pressure is higher than atmospheric pressure.

The method may also comprise the step consisting of introducing a fluid, particularly a coolant, into the vacuum chamber in contact with the flexible wall in order to provide energy useful for polymerisation of the resin. The presence of the coolant in the vacuum chamber can improve heat transfer to the composite part and thus reduce part manufacturing cycles.

The manufacturing method according to the invention may comprise any one of the above-mentioned characteristics taken individually, or in any technical possible combination with other characteristics.

### BRIEF DESCRIPTION OF THE DRAWINGS

The invention will be better understood after reading the detailed description given below of non-limitative example embodiments of it, with reference to the diagrammatic and partial figures of the appended drawing on which:

FIG. 1 shows a sectional view of an example device for fabrication of a composite part using the RTM method according to prior art;

FIG. 2 shows a sectional view of an example device for fabrication of a composite part using the LRI method according to prior art;

FIG. 3 shows a sectional view of an example device for fabrication of a composite part using the MVI method according to prior art;

FIG. 4 shows a sectional view of an example device for fabrication of a composite part according to the invention;

FIG. 5 shows a sectional view of an example device for fabrication of a composite part according to the invention; and

FIGS. 6a and 6b show a sectional view of a variant embodiment of a device according to the invention comprising a press clave, before and after closing the press clave respectively.

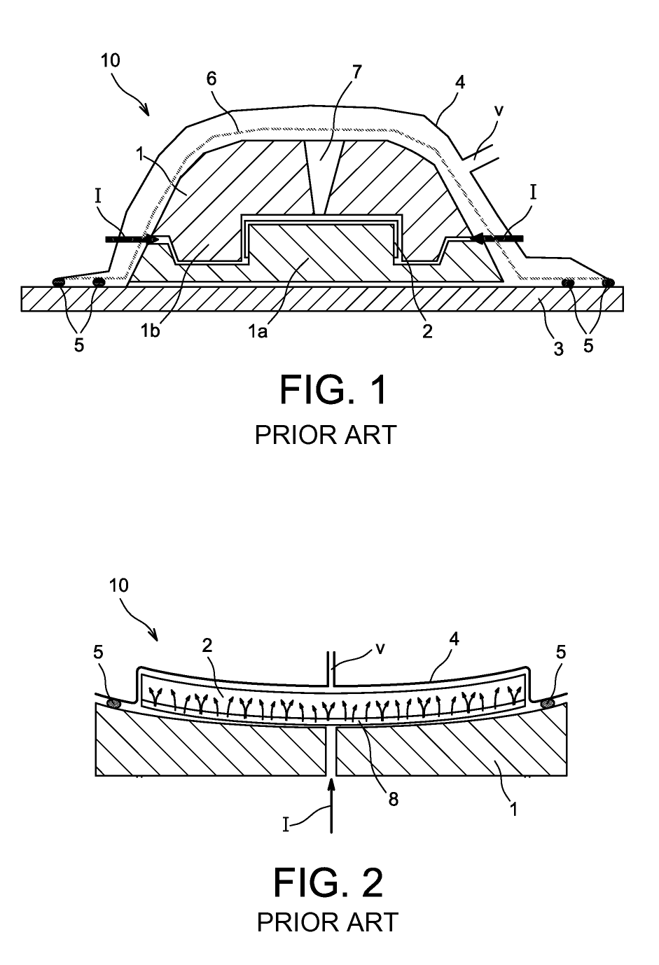

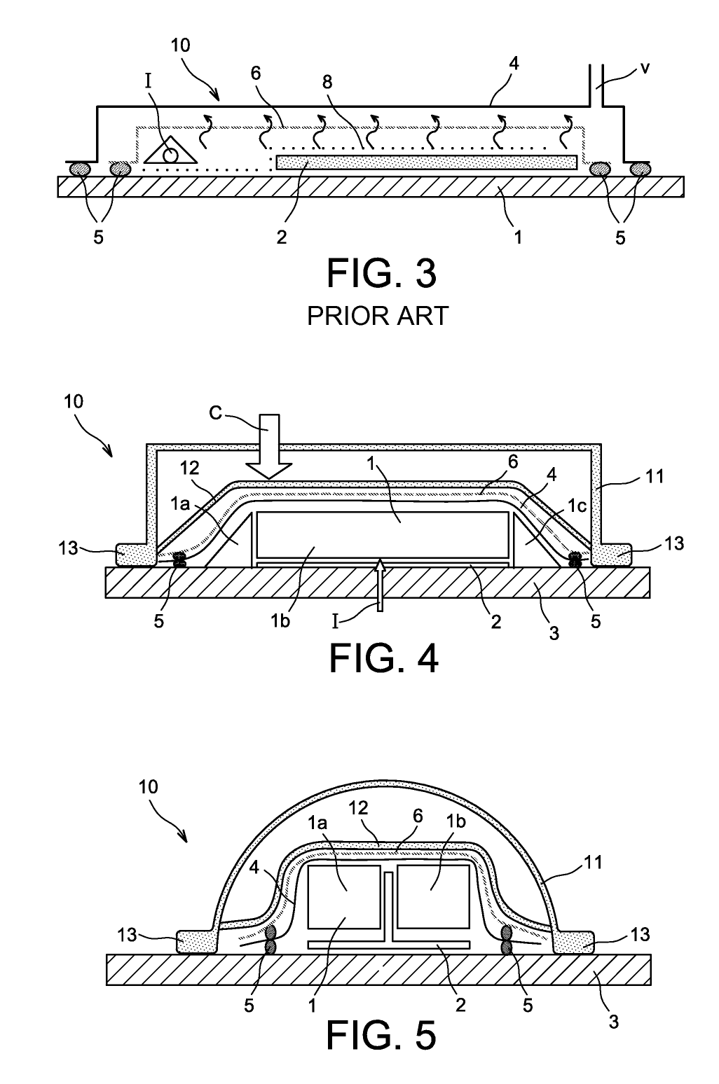

Identical references are used in all these figures to denote identical or similar elements.

### DETAILED DESCRIPTION OF PARTICULAR EMBODIMENTS

We will now describe embodiments of the invention related to devices 10 for manufacturing a composite part, with reference to FIGS. 4 to 6b.

FIG. 4 shows a device 10 for manufacturing a composite part comprising a support element 3 on which a mould 1 composed of three parts 1a, 1b and 1c is supported.

The three parts 1a, 1b and 1c of mould 1 form a cavity, in which a preform 2 placed in contact with the support element 3 will be housed.

The device 10 also comprises a vacuum creation membrane 4 that covers the mould 1 and bears on the support element 3 through seals 5, on each side of the preform 2.

The composite part is manufactured by injection of resin to form the matrix of the composite part at the injection holes I by coming into contact with the preform 2.

According to the invention, the device 10 also comprises a vacuum chamber 11 fitted with a flexible wall 12 (or bladder) connected to the ends of the vacuum chamber 11. The vacuum chamber 11 is supported on the support element 3 through seals 13.

The use of a vacuum chamber 11 fitted with a flexible wall 12 according to the invention can increase the resin injection pressure at the contact with the preform 2 up to a pressure higher than atmospheric pressure. In particular, the flexible wall 12 may mean that an isostatic pressure can be applied, particularly to a porous material 6, for example a drain felt, above the vacuum creation membrane 4 so as to put the entire mould 1 at atmospheric pressure, the injection pressure (or feed pressure) of the resin being higher than atmospheric pressure. Consequently, if for example the vacuum creation membrane 4 should burst or if there is a poor seal around the mould 1, it is impossible to create a fluid (gas or liquid) leak except from the inside of the mould 1 to the outside of the mould 1, and it is not necessary to scrap the composite part. If a leak is excessive, it can be compensated by additional injection of resin at the preform 2.

The use of a vacuum creation membrane 4 can be advantageous in terms of costs and fabrication quality of the composite part.

Furthermore, the invention can improve the control of the geometry of the fabricated composite part because the pressure at the flexible wall 12 opposes deformation of the mould 1 during injection of the resin and polymerisation of the resin. It is also possible to facilitate control of the resin injection pressure relative to the pressure at the flexible wall 12 for example using a pressure reducer to achieve a constant pressure difference between the vacuum chamber 11 and the mould 1.

The device 10 also comprises a porous material in the form of a drain felt 6 inserted between the vacuum creation membrane 4 and the flexible wall 12 of the vacuum chamber 11.

The presence of the drain felt 6, for example a fabric, can be sufficient to assure that the interface between the vacuum creation membrane 4 and the flexible wall 12 is at atmospheric pressure, so as to make sure that the resin injection pressure is higher than atmospheric pressure.

The vacuum chamber 11 may also comprise a C inlet connector to enable passage of a coolant into the vacuum chamber in contact with the flexible wall 12. The passage of such a coolant in particular can give better heat transfer towards the composite part to shorten fabrication cycles.

In the example in FIG. 4, the vacuum chamber 11 has a generally rectangular cross-sectional shape, but this example embodiment is in no way limitative.

In particular, in the example in FIG. 5, the vacuum chamber 11 has an approximately semi-circular cross-sectional shape. For example, the vacuum chamber 11 may be approximately semi-cylindrical. Furthermore, in this example in FIG. 5, the preform 2 extends both on the support element 3 and partially between parts la and lb of the mould 1.

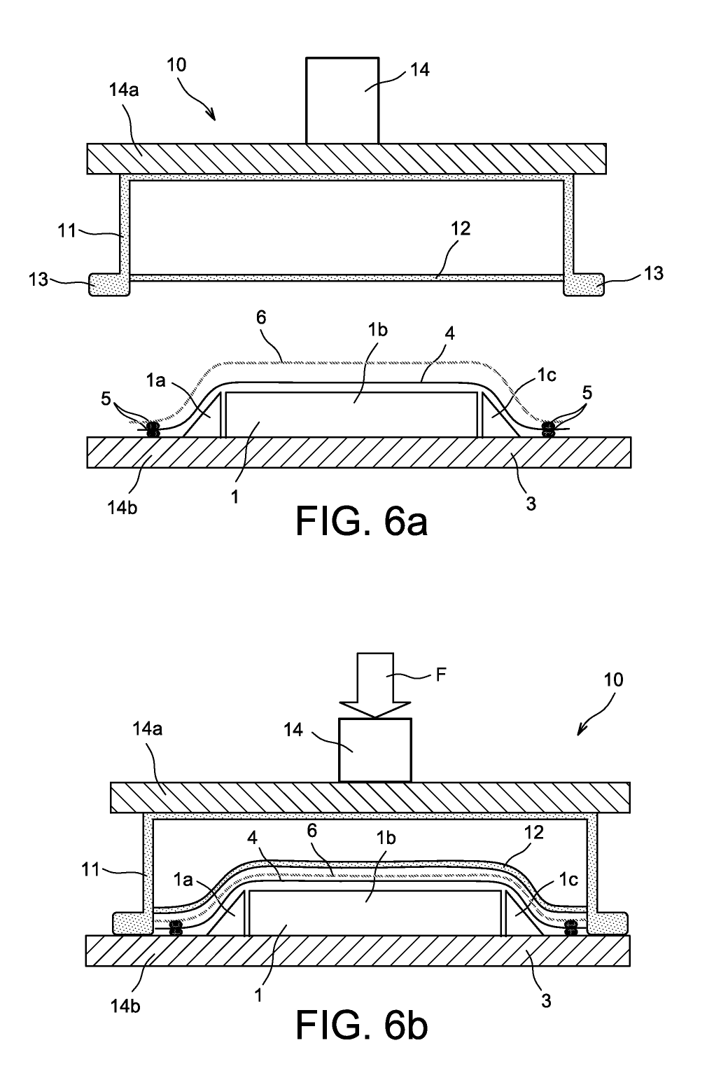

FIGS. 6a and 6b illustrate the possibility of automating the device 10 by incorporating a press clave 14 into it.

More precisely, the device 10 may comprise a press clave 14 fitted with a first part 14b on which the mould 1 is supported and a second part 14a on which the vacuum chamber 11 fitted with the flexible wall 12, is fixed. In the example in FIGS. 6a and 6b, the press clave 14 is thus composed of two parts. As a variant, the press clave 14 may comprise a single part on which the vacuum chamber 11 is fitted.

FIG. 6a shows such a device 10 in the configuration in which the press clave 14 is open, and FIG. 6b shows the device 10 in the configuration in which the press clave 14 is closed by creating movement of the second part 14a along the direction of arrow F.

When the second part 14a of the press clave 14 closes on the first part 14b, the flexible wall 12 applies a mechanical pressure on the vacuum creation membrane 4 so as to increase the resin injection pressure above atmospheric pressure.

When the press clave 14 is closed, it may be preferable to control the pressure above the flexible wall 12 by a fluid pressure (gas or liquid) contained in the vacuum chamber 11. However, control of the closing force of the second part 14a on the first part 14b can control the collapsing pressure of the flexible wall 12 between the side walls of the vacuum chamber 11 and the first part 14b, to give a better seal to maintain sufficient pressure inside the vacuum chamber 11 when this pressure varies during a resin injection and feed cycle.

Obviously, the invention is not restricted to the example embodiments that have just been described above. Those skilled in the art can make various modifications to it.

The device and the method according to the invention can enable the fabrication of various types of composite parts, particularly composite parts usually made by known methods like vacuum-assisted RTM, LRI or MVI. The invention has applications particularly in the field of aeronautics, for example for manufacturing the landing gear doors of an aircraft.

The expression [symbol] comprising one [symbol] should be understood as being synonymous with [symbol] comprising at least one [symbol] , unless mentioned otherwise.

1. Device for manufacturing a composite part, comprising:
a mould, designed to be associated with a reinforcement of the composite part comprising a preform, into which the resin forming the matrix of the composite part will be injected,
possibly a support element on which the mould is supported,
a preform vacuum creation membrane supported on the mould and/or the support element if there is one,
characterised in that it also comprises a vacuum chamber covering the vacuum creation membrane, the vacuum chamber comprising a flexible wall designed to apply a mechanical pressure on the vacuum creation membrane.

2. Device according to claim 1, characterised in that it also comprises at least one seal at the interface between the vacuum creation membrane and the mould and/or the support element if any.

3. Device according to claim 1, characterised in that the vacuum chamber is capable of entirely covering the vacuum creation membrane by being supported on the mould and/or the support element if any, on each side of the preform.

4. Device according to claim 1, characterised in that the flexible wall is connected to the periphery of the vacuum chamber.

5. Device according to claim 1, characterised in that the mould is formed from several parts.

6. Device according to claim 1, characterised in that the vacuum chamber comprises at least one seal designed to bear on the mould and/or the support element.

7. Device according to claim 1, characterised in that the vacuum chamber comprises an inlet connector for the passage of a fluid into the vacuum chamber at the contact with the flexible wall.

8. Device according to claim 1, characterised in that it comprises a porous material between the vacuum creation membrane and the flexible wall of the vacuum chamber.

9. Device according to claim 1, characterised in that it comprises a press clave made from a single part, on which the vacuum chamber fitted with the flexible wall is installed.

10. Device according to claim 1, characterised in that it comprises a press clave in two parts, comprising a first part on which the mould is supported and a second part on which the vacuum chamber fitted with the flexible wall is installed.

11. Device according to claim 1, characterised in that it comprises a surface resin diffuser.

12. Method of manufacturing a composite part by a device according to claim 1, comprising covering the vacuum creation membrane with the vacuum chamber such that the flexible wall of the vacuum chamber applies a mechanical pressure on the vacuum creation membrane such that the resin injection pressure is higher than atmospheric pressure.

13. Method according to claim 12, characterised in that it comprises introducing a fluid, particularly a coolant, into the vacuum chamber, in contact with the flexible wall in order to provide energy useful for polymerisation of the resin.
